(19) United States
(12) Patent Application Publication
(10) Pub. No.: US 2012/0147050 A1
(43) Pub. Date: Jun. 14, 2012

(54) METHOD OF ENTERING A COMMAND FOR ZOOMING IMAGE SHOWN ON TOUCH SCREEN AND TOUCH SCREEN DEVICE READING SUCH COMMAND

(75) Inventors: HSIN-KUO DAI, New Taipei (TW); KUN-TE CHENG, New Taipei (TW); WEN-KAI TSAI, New Taipei (TW); HSIANG-HUI SHEN, New Taipei (TW); KAI YANG, New Taipei (TW); YU-MIN WANG, New Taipei (TW)

(73) Assignee: HON HAI PRECISION INDUSTRY CO., LTD., New Taipei (TW)

(21) Appl. No.: 13/315,545

(22) Filed: Dec. 9, 2011

(30) Foreign Application Priority Data
Dec. 9, 2010 (TW) 099143118

(51) Int. Cl. G09G 5/00; G06F 3/041

(52) U.S. Cl. 345/660

(57) ABSTRACT

A method for zooming image shown in a touch screen includes reading information of a continuous writing locus formed on the touch screen; selecting a first group of points and a second group of points in the writing locus formed in time sequence; dealing with the first group and second group of points and obtaining a first radius and a second radius; comparing the first radius and the second radius to define a zooming command; executing the zooming command. A touch screen reading such writing locus into zooming command is also provided.

### BACKGROUND OF THE INVENTION

1. Field of the Invention

The present invention relates to a method for entering a command for zooming image shown in a touch screen and a touch screen reading such command.

2. Description of Related Art

A conventional method for zooming image shown in a touch screen is disclosed in U.S. Pat. No. 7,864,161 B2 issued to Hollemans. To operate the command of zooming the image usually needs two fingers to move on the touch screen. However, it is not quite convenient to operate and a more expensive capacitive touch screen is needed to read such command.

U.S. Patent Application publication No. 2006/0026536A1 relates to gesturing associated with touch sensitive devices and mentions that a wide range of different gestures can be utilized. The gestures may be single point or multipoint gestures; static or dynamic gestures; continuous or segmented gestures; and/or the like. Single point gestures are those gestures that are performed with a single contact point, e.g., the gesture is performed with a single touch as for example from a single finger, a palm or a stylus. During a zooming gesture, the fingers may spread apart or close together in order to cause the object shown on the screen or a separate display to zoom in during the spreading and zoom out during the closing. During this operation, the computer system recognizes the user input as a zoom gesture, determines what action should be taken, and outputs control data to the appropriate device.

There is a need to provide a method for conveniently executing a command for zooming image in a touch screen.

### SUMMARY OF THE INVENTION

An object of the present invention is to provide a method for zooming image shown in a touch screen under a command being entered by a continuous writing locus of one stylus thereon. The method comprises the following steps: reading information of times and positions of a plurality of discrete points in a continuous writing locus formed on the touch screen by a stylus; selecting a first group of points in the writing locus formed at an earlier first time and a second group of points in the writing locus formed at a later second time; dealing with the first group of points and obtaining a first radius approximating to a radius at one point of the first group, dealing with the second group of points in the writing locus and obtaining a second radius approximating to a radius at one point of the second group; comparing the first radius and the second radius to define a zooming command; executing the zooming command.

Another object of the present invention is to provide a touch screen device being able to translate a continuous writing locus of one stylus thereon into command of zoom image shown therein. The touch screen comprises: a touch screen that can read information of times and positions of discrete points disposed in a writing locus when one stylus writes on the touch screen continuously; a process unit being loaded with a software to get radius at the discrete points in the writing locus, and define a zooming command according to the radius of curvature.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 shows a writing locus and exemplary discrete points disposed in the writing locus;

FIG. 2 is a group of equations to get a first radius of a first circle shown in FIG. 1;

FIG. 3 is a group of equations to get a second radius of a second circle shown in FIG. 1;

FIG. 4 is a writing locus of involute formed by a finger moving on a touch screen to enter a number of zooming in commands; and

FIG. 5 is a writing locus of anti-involute formed by a finger moving on a touch screen to enter a number of zooming out commands.

### DETAILED DESCRIPTION OF THE INVENTION

Reference will now be made to the drawing figures to describe the present invention in detail.

As is defined in geometry, the radius of curvature of a curve at a point is a measure of the radius of the circular arc which best approximates the curve at that point. A method for zooming image shown in a touch screen is provided, implemented as a zooming command entered by a continuous writing locus of a stylus on the touch screen. The method comprises the following steps:

(1) reading information of times and positions of a plurality of discrete points in a continuous writing locus formed on the touch screen by a stylus;

(2) selecting a first group of points in the writing locus formed at an earlier first time and a second group of points in the writing locus formed at a later second time;

(3) calculating, from the first group of points, a first radius approximating to a radius of curvature at one point of the first group and, from the second group of points in the writing locus, a second radius approximating to a radius of curvature at one point of the second group;

(4) comparing the first radius and the second radius to define a zooming command in the following way: if the second radius of curvature were greater than the first radius of curvature, the zooming command is zooming in the image shown in the touch screen; if the second radius of curvature were less than the first radius of curvature, the zooming command is zooming out the image shown in the touch screen;

(5) executing the zooming command.

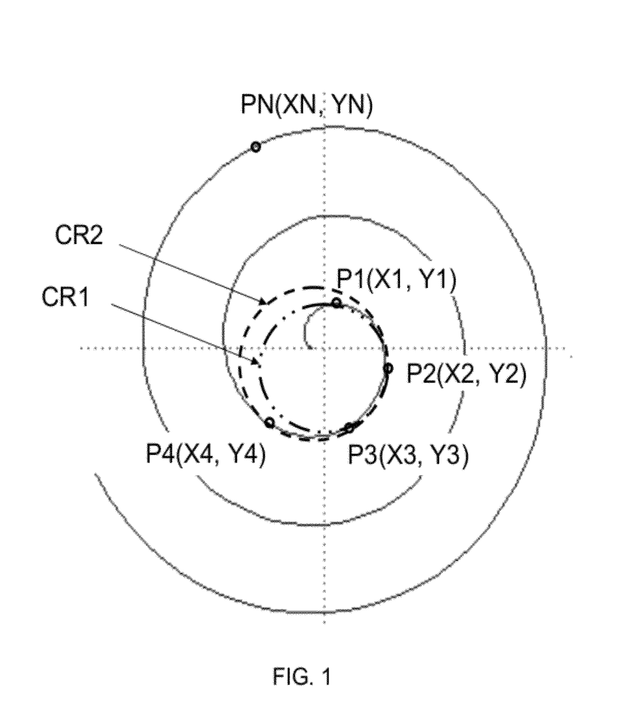

During step (1), referring to FIG. 1, when an involute line is written, the points are selected in time sequence as P1, P2, P3, P4 . . . PN, the positions could be read as (X1, Y1), (X2, Y2), (X3, Y3), (X4, Y4) . . . (XN, YN) in a Cartesian coordinate system.

During step (2), a first group of points of P1, P2 and P3 and a second group of points of P2, P3 and P4 in the writing locus are chosen.

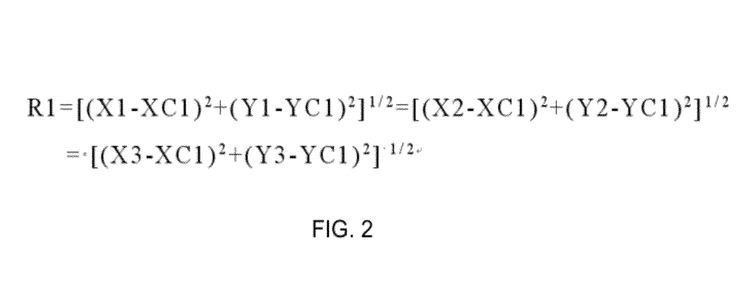

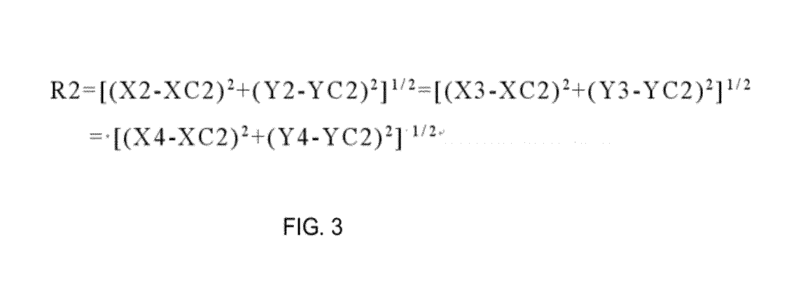

During step (3), the first group of points of P1, P2 and P3 determine a first radius R1 of a common imaginary circle CR1 in which the first group of points are disposed. The second group of points of P2, P3 and P4 determine a second radius R2 of a common imaginary circle CR2 in which the second group of points are disposed. The positions of the center points of the common imaginary circles CR1 and CR2 are (XC1, YC1) and (XC2, YC2). Two groups of equations respectively shown in FIGS. 2 and 3 are obtained in that distance between each point in the circle and the center point equals the radius of the circle.

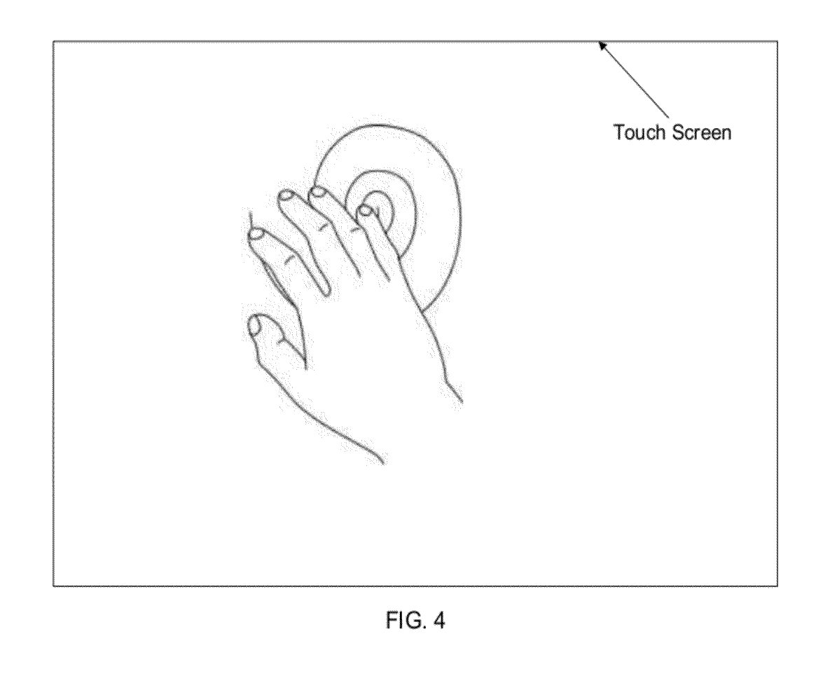

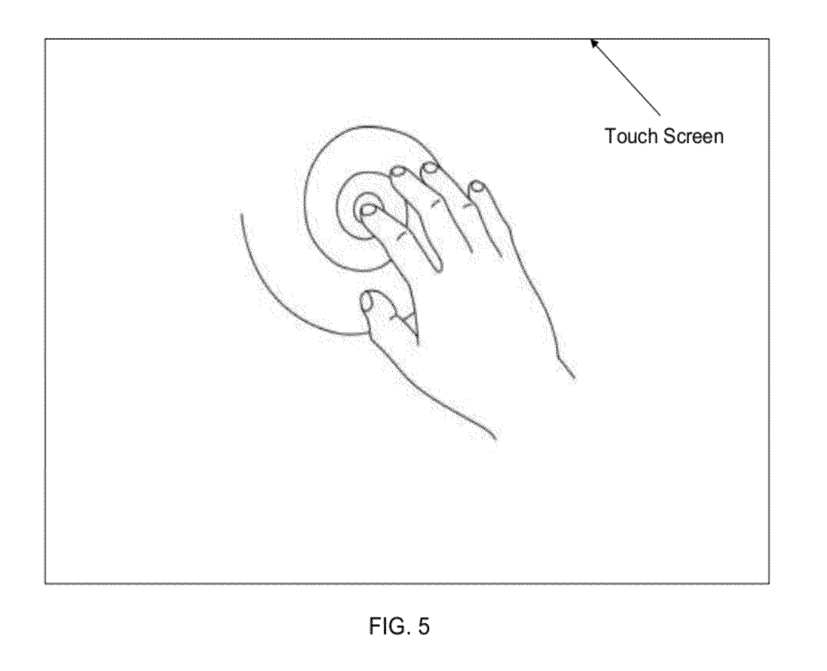

When a user of a touch screen needs to zoom an image shown in the touch screen, he/she just needs to write a continuous writing locus with a stylus on the touch screen and a number of commands for zooming the image shown in the touch screen would be executed. When the image shown in the touch screen is needed to be zoomed in, the stylus is operated to move on the touch screen along an involute (referring to FIG. 4) so that a number of commands of zooming in are executed. When the image shown in the touch screen is needed to be zoomed out, the stylus is operated to move on the touch screen along an anti-involute (referring to FIG. 5) so that a number of commands of zooming out are executed.

Additionally, in order to improve accuracy of the command, the points at the end of the locus could be discarded, and if a number of commands were entered in a continuous writing locus, a single command different from the others is discarded and not executed.

In an alternative embodiment, the software is so configured that if the stylus is routed along a continuous curved locus clockwise, commands of zooming in are executed, and if the stylus is routed along a continuous locus anticlockwise, commands of zooming out are executed, and vice versa.

What is claimed is:

1. A method for zooming image shown on a touch screen under a command implemented by a continuous writing locus of a stylus on the touch screen, comprising the steps of:
reading information of times and positions of a plurality of discrete points in a continuous writing locus formed on the touch screen by a stylus;
selecting a first group of points in the writing locus formed at an earlier first time and a second group of points in the writing locus formed at a later second time, at least one point of the second group formed at a time later than any points of the first group;
dealing with the first group of points and obtaining a measure of a first radius, dealing with the second group of points in the writing locus and obtaining a measure of a second radius;
comparing the first radius and the second radius to determine a zooming command;
executing the zooming command.

2. A method for zooming image shown in a touch screen as claimed in claim 1, wherein the zooming command is determined on provision that:
if the second radius were greater than the first radius of curvature, the zooming command is zooming in the image shown in the touch screen; and
if the second radius were less than the first radius, the zooming command is zooming out the image shown in the touch screen.

3. A method for zooming image shown in a touch screen as claimed in claim 1, wherein for discrete points selected in time sequence to be P1, P2, P3, P4 . . . PN, the step of selecting comprises obtaining the first radius of an imaginary circle in which the first group of points P1, P2, and P3 are disposed and obtaining the second radius of an imaginary circle in which the second group of points P2, P3, and P4 are disposed.

4. A method for zooming image shown in a touch screen as claimed in claim 1, wherein the points are selected in equal length along the writing locus between any adjacent selected points.

5. A method for zooming image shown in a touch screen as claimed in claim 1, wherein the points in the writing locus are read continuously as the stylus is on writing so that a series of zooming commands are executed.

6. A method for zooming image shown in a touch screen as claimed in claim 5, wherein a single instance of command that is different from the other commands is discarded.

7. A device for translating a continuous writing locus of a stylus on a touch screen into command of zooming image, comprising:
a touch screen for reading information of times and positions of discrete points disposed in a writing locus when a stylus writes on the touch screen continuously;
a process unit configured to obtain a radius defined by the discrete points in the writing locus and determine a zooming command according to the radius.

8. A device as claimed in claim 7, wherein the process unit is configured to choose a first group of at least three points formed at an earlier time and a second group of at least three points formed at a later time, the first group of points being used to get a first radius of an imaginary circle in which the first group of points are disposed, the second group of points being selected to get a second radius of an imaginary circle in which the second group of points are disposed, the first radius and the second radius being compared to define the zooming command.

9. A device as claimed in claim 8, wherein the zooming command is determined on the provision that:
if the second radius were greater than the first radius, the zooming command is zooming in the image shown in the touch screen; and
if the second radius were less than the first radius, the zooming command is zooming out the image shown in the touch screen.

10. An arrangement to verify a command with regard to zooming in or zooming out for a picture on a screen of the display device, comprising:
a touch screen defining X and Y axes extending along first and second directions perpendicular to each other; and
a piece including an end point touching the touch screen along a moving path; wherein
said moving path continuously extends in both the first direction and the second direction to result in one of zoom-in and zoom-out commands when said moving path is essentially clockwise, or the other when said moving path is essentially counterclockwise.

11. The arrangement of claim 10, wherein said piece is a finger.
